(19) United States
(12) Patent Application Publication
(10) Pub. No.: US 2005/0219272 A1
(43) Pub. Date: Oct. 6, 2005

(54) Non-emissive display device with automatic grey scale control

(76) Inventors: Mark Thomas Johnson, Eindhoven (NL); Alexander Victor Henzen, Heerlen (NL); Hugo Johan Cornelissen, Eindhoven (NL); Guo Fu Zhou, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/515,471

(22) PCT Filed: Apr. 28, 2003
(86) PCT No.: PCT/IB03/01718

§ 371 Date: Nov. 22, 2004

(30) Foreign Application Priority Data
May 24, 2002 (EP) 02077045.9

(51) Int. Cl. G09G 5/10

(52) U.S. Cl. 345/690; 345/207

(57) ABSTRACT

This invention relates to an non-emissive display device which is arranged to operate using electro-optical modes, said display device comprising at least one individually addressable pixel (1,10), wherein at least one of scattering and absorption of light is arranged to occur within said pixel. The device comprises means for monitoring a grey scale level (8b,8c,8d,8e,15) within said at least one pixel (1,10), means for adjusting the grey scale level (20,21) of said pixel (1,10) and means for feeding grey scale information from said monitoring means to said adjusting means in order to control said adjusting means. The invention also relates to a method of driving a pixel of such a non-emissive display device.

This invention relates to non-emissive displays which operate using electro-optical modes, said display comprising at least one individually addressable pixel, wherein scattering and/or absorption of light occurs within the pixel cell. The invention also relates to a method for driving such a display.

In order to improve the usability of non-emissive displays, such as displays based on polymer dispersed liquid crystals (PDLC), cholesteric textured liquid crystals (CTLC), Guest-host systems (G-H) electrochromic systems, “Gyricon” systems (trademark of Xerox Corp.) and hybride switchable mirror systems (HM), greyscales should be provided. In all display types described above, problems may be encountered in correctly setting grey scale levels, ensuring that the grey scales are uniform across the displays and that they do not drift in time. This is well illustrated by referring to the situation in electrophoretic displays. In the prior art electrophoretic displays, grey scales have been created by applying voltage pulses for specified time periods. However, such displays are strongly influenced by external factors, such as temperature, the reset state of the display, and lateral inhomogeneity of electrophoretic foils and moreover such displays are observed to drift with time, and respond to residual DC voltages and exhibit image retention. A further method for providing grey scale capability is described in the patent document U.S. Pat. No. 5,254,981, in which a plurality of adjacent pixels are driven to form patterns of black and white digital pattern, where the combination causes a desired visible grey scale level.

However, a problem with these prior art displays is that they exhibit an unsatisfactory grey scale accuracy, and moreover, the grey scale tend to drift with time.

Hence, an object of this invention is to provide a non-emissive display which operate using electro-optical modes, wherein scattering and/or absorption of light is arranged to occur within the pixel cell, having an improved grey scale accuracy, as well as a decreased grey scale drift.

The above and other objects are achieved by the invention by a non-emissive display device as described by way of introduction, being characterised in that the device comprises means for monitoring a grey scale level within said at least one pixel, means for adjusting the grey scale level of said pixel and means for feeding grey scale information from said monitoring means to said adjusting means in order to control said adjusting means. Thereby, both the grey scale accuracy is improved and the grey scale drift is reduced. As indicated above, such non-emissive display devices, with which the invention may be used, are for example devices based on polymer dispersed liquid crystals (PDLC), cholesteric textured liquid crystals (CTLC), Guest-host systems (G-H) electrochromic systems, “Gyricon” systems (trademark of Xerox Corp.) and hybride switchable mirror systems (HM).

Suitable, said display device has a bi-stable nature. Examples of such devices are devices based on electrophoretic (EP) materials, electrochromic (EC) materials, cholesteric textured liquid crystals (CTLC), hybride switchable mirrors (HM) and some types of guest-host systems (G-H). Preferably, said display device is an electrophoretic display device.

Preferably, said monitoring means comprises a photo-sensitive device, arranged within said pixel, being an simple way of monitoring said grey scale level, which may easily be implemented in electrophoretic displays.

According to a first preferred embodiment of this invention, said display device is of a reservoir type, wherein the pixel has an associated reservoir, said photo-sensitive device being arranged in proximity with a reflective element of said pixel. Hereby, the amount of un-absorbed light may be measured directly, and moreover this construction facilitates that the transistors of the active plate of the display can be used for realising the monitoring of the grey scale and the feed back circuits, since the reflective element commonly is arranged on the active plate. Preferably, said photo-sensitive device is a structured device being arranged on the surface of said reflective element. This has the advantage that it provides a good measure of the average light absorption in the pixel.

According to a second preferred embodiment, said display device is an electronic ink display device. Such an electrophoretic “electronic ink” display device is for example provided by the E-Ink Corporation. Here, charged particles are dispersed in a liquid and enclosed within capsules, which results in a robust display with high stability. In this case, said photo-sensitive device is arranged to monitor the amount of light scattered from said pixel (this arrangement is also possible with the first preferred embodiment). This embodiment may be applied to display devices which do not have a transparent state.

Preferably, said adjusting means is arranged to completely set a desired grey scale level, to fine-tune an already set grey scale level or to prevent a set grey level from further drifting in time. Hence, the present invention provides a flexible solution which may be used in a plurality of ways.

In a further embodiment, the display device according to this invention, and specifically an electrophoretic display device comprises a plurality of individually addressed pixels, and the display further comprising means for measuring an intensity of ambient light falling onto said display device, wherein the information regarding the ambient light intensity may be used as a reference for the grey scale level. This further improves the usability of the display. Preferably, said means for measuring an intensity of ambient light comprises a plurality of photodiodes being arranged in said display device, such as around a periphery of said display device. In this way, variations in the ambient light intensity across the display may be accounted for.

The above and other objects of the invention are also achieved by a method for driving a pixel of a non-emissive display device which operate using electro-optical modes, wherein scattering and/or absorption of light occurs within the pixel cell as described above, comprising the following steps:
monitoring, by means of a monitoring means, a grey scale level of said pixel,
feeding grey scale level information as provided by said monitoring means, to a pixel grey scale adjusting means arranged for said pixel, and
adjusting the grey scale level of said pixel, based on said grey scale level information.

Further embodiments of this invention are evident from the further dependent claims, from the drawings and from the description.

### BRIEF DESCRIPTION OF THE DRAWINGS

The invention will hereinafter be described by way of examples, with reference to the accompanying drawings.

FIG. 1a-1e is a schematic cross-section of a prior art display (1a) and four alternatives of a first embodiment of this invention (1b-1e).

FIG. 2a-2b is a schematic cross-section of two alternatives of a second embodiment of this invention.

FIG. 3 is a schematic circuit diagram for realising photo-sensor feedback in order to define grey scales.

FIG. 4 is a schematic circuit diagram of an electrophoretic display pixel with integral photo-sensor to enhance display uniformity.

### DESCRIPTION OF PREFERRED EMBODIMENTS

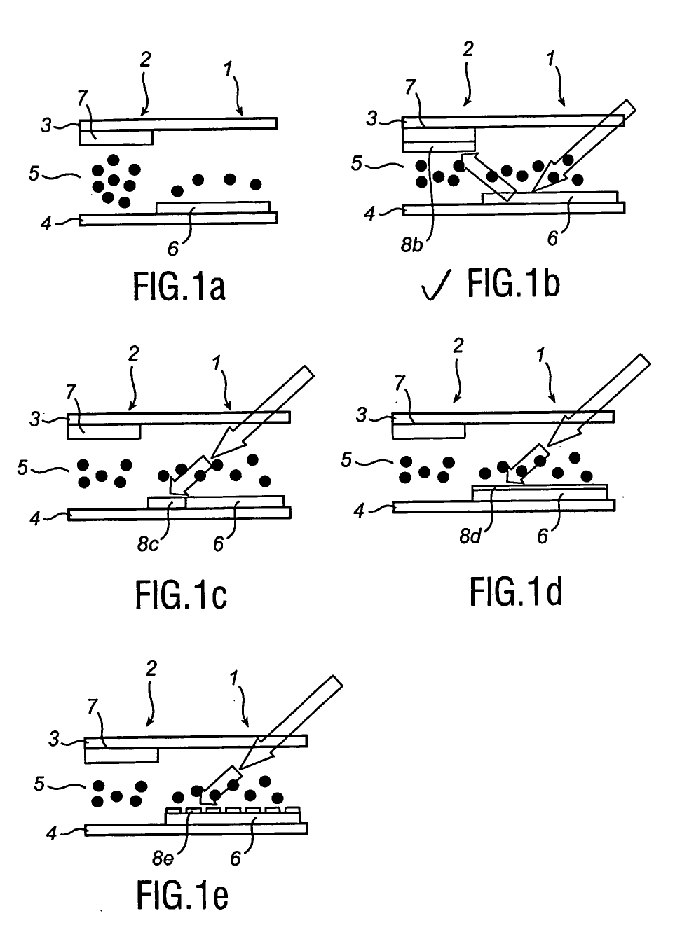

A first main embodiment of the invention will now be described with reference to fig 1a-1e. FIG. 1a discloses a cross section of a display element of a non-emissive display, here an electrophoretic display of reservoir type in accordance with prior art, comprising a pixel part 1 and a reservoir part 2. A display is built up by a plurality of such pixel elements, being driven by active matrix driving. The driven pixel element comprises a layer of electrophoretic material 5, such as a transparent, translucent or light coloured solution carrying dark coloured, absorbing particles, being arranged between a front layer 3 and a back layer 4, being an active plate. In the pixel part 1, on said back layer, a reflecting element 6 is arranged to reflect ambient light falling onto the display and entering through the electrophoretic layer 5, and in the reservoir part 2, on said front layer a blocking element 7 is arranged to block ambient light from entering directly into the reservoir part of the display device. Depending on the state of driving, the coloured particles of the electrophoretic layer 5 may move in and out of the visible pixel part and thereby generate a desired visible grey level of the pixel part. As indicated above, in this display, ambient light is allowed to pass through the electrophoretic layer 5 and onto the back layer, being an active plate. According to the invention the intensity of the incident light falling onto the pixel part 2 may be measured, this being a measure of the grey scale level of the pixel. This may be done by using a photo-sensor 8b, 8c, 8d, 8e.

According to a first alternative, as shown in fig 1b, the photo-sensor 8b may be positioned in the reservoir part 2 of the display element, adjacent to the pixel part 1. In this case, light is detected by the photo-sensor 8b after being reflected by the reflecting element 6 in the pixel part 2. A portion of the incident light is absorbed by the coloured particles being present in the pixel part, and hence the photo-sensor signal detected will be dependant upon the amount of coloured particles present in the pixel part 2.

According to a second alternative, as shown in FIG. 1c, a photo-sensor 8c is located adjacent to the reflecting element 6 on the back layer 4 of the display device. A part of the incident light will be absorbed by the coloured particles present in the pixel part 1, and hence the detected photo-sensor signal will be altered accordingly. Preferably, the photo-sensor 8c is situated at the edges of the pixel, or even on top of an electrode within the pixel part, where the light loss will be limited. This alternative has the advantage that the photo-sensor 8c is situated on the active substrate, whereby integration is possible.

According to a third alternative, as shown in FIG. 1d, the photo-sensor 8d is arranged directly above the reflecting element of the pixel part 1. This alternative has the advantage that the photo-sensor 8d may detect light falling into all portions of the pixel part, and hence, the photo-sensor 8d may measure the actual total light absorption of the pixel.

According to a fourth alternative, as shown in FIG. 1e, the photo-sensor 8e is arranged directly above the reflecting element of the pixel part 1, in the form of a grid or other pattern. In this case, the photo-sensor 8e may provide a good measure of the average light absorption in the pixel, whilst only minimally reducing the brightness of the pixel.

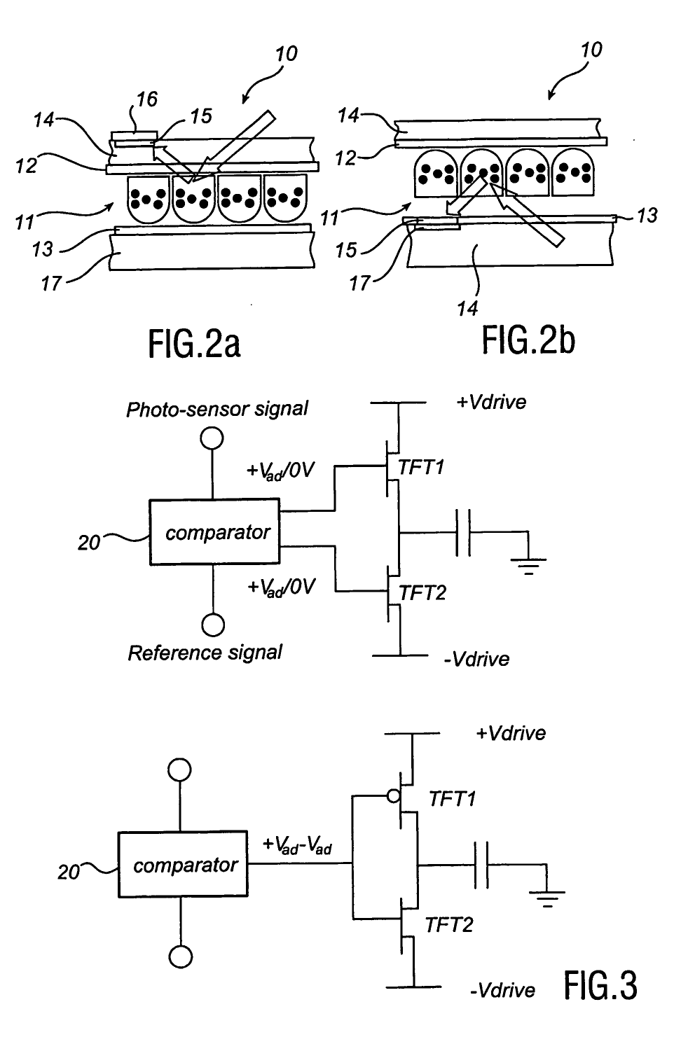

A second main embodiment of the invention will now be described with reference to FIG. 2a-2b.

FIG. 2a and FIG. 2b both disclose a cross section of a display element or pixel 10 of an electrophoretic display of electronic ink type. This display element comprises a layer 111 comprising a plurality of microcapsules, said layer 11 being arranged between first and second electrodes 12, 13 arranged for active matrix driving, forming pixels. Each microcapsule comprises an amount of electrophoretic material, such as a clear fluid carrying light coloured as well as dark coloured particles, being oppositely charged (it is also possible to use light and dark charged particles with fluids of complementary colours). Thereby the position of the light and/or dark particles within the microcapsule may be altered by applying an electric field over it, and hence it may be controlled whether the pixel shall be light (light particles positioned on the viewing side of the microcapsules and/or dark particles positioned away from the viewing side of the microcapsules) or dark (dark particles positioned on a viewing side of the microcapsules and/or light particles positioned away from the viewing side of the microcapsules).

Further, the first electrode is arranged on an optical foil 14 and the second electrode 13 is arranged on a TFT substrate 17. In electrophoretic displays of electronic ink type, it is generally not possible for incident light to pass through the electrophoretic layer, and hence measuring of the grey scale level of the display is preferably made by measuring the amount of scattered light from a pixel.

According to a first alternative, a photo-sensor 15 is positioned above the first electrode 12, on the foil side of the display. The photo-sensor 15 is protected by means of a black matrix 16, being positioned above said photo-sensor 15, in order to prevent detection of direct incident light upon the photo-sensor. Thereby, light scattered from white particles of the microcapsules in a pixel region is arranged to be detected by the photo-sensor 15. Since a part of the incident light may have been absorbed by dark particles in the pixel, the amount of scattered light will vary, depending on the amount of black particles in the pixel area.

According to a second alternative of the second main embodiment, a photo-sensor 15 is positioned on or adjacent to the pixel electrode on the TFT substrate 17. In this case, the display is to be viewed from the TFT substrate side of the display device. As above, detection of direct light is prevented by a black matrix protecting the photo-sensor. As above, some of the incident light will be absorbed by black particles in the pixel, and hence the amount of scattered light as well as the photo-sensor signal is altered accordingly. Preferably, the photo-sensor is situated at the edges of the pixel, or even on top of electrodes within the pixel. This alternative has the advantage that the photo-sensor may detect light falling into all portions of the pixel part, and hence, the photo-sensor may measure the actual total light absorption of the pixel. Moreover the photo-sensor may be arranged directly above the pixel, in the form of a grid or other pattern in the same way as in FIG. 1e. In this case, the photo-sensor may provide a good measure of the average light absorption in the pixel, whilst only minimally reducing the brightness of the pixel.

For some applications it may be suitable to correct the display in accordance with ambient light intensity, and for this purpose two possible solutions will hereinafter be described.

According to a preferred embodiment, the intensity of the incoming light is monitored by a plurality of photodiodes, arranged around the periphery of the display in order to determine what the local brightness of the incident light across the display is. The photodiodes may even be arranged within the display, however not being covered by electrophoretic particles.

Alternatively, the incident light distribution may be measured across the entire display area, just before the grey level is set, by removing all electrophoretic particles from the display, and using this measurement as a reference to set the pixel grey level. In this case, a pixel memory unit may be incorporated in the display, in order to carry out a comparison with the reference level during grey scale level setting. Methods to include pixel memory are well known for example in the preferred poly-Si technology, and will therefore not be closer described herein.

A method for applying a photo-sensor feedback from the above described photo-sensors in order to set grey levels in an electrophoretic display in accordance with the invention will hereinafter be described. Similar approaches can be envisaged for applying a photo-sensor feedback to any of the other bi-stable displays described above, which fall within the scope of this invention, i.e. electrochromic (EC) displays, cholesteric textured liquid crystal (CTLC) displays, hybride switchable mirror (HM) displays and some types of guest-host systems.

Even if there are several ways of creating grey levels in electrophoretic displays (disclosed in the prior art), they all rely on the basic principle that charged particles respond to an electrical field and its polarity, and hence the polarity of the field determines whether the pixel becomes brighter or darker when the field is applied. According to an embodiment of this invention, the output from the above photo-sensor is used to determines the polarity of an applied field. An example of a schematic circuit carrying out this operation is disclosed in FIG. 3.

The operation of the feedback may proceed as follows:

Step 1

Determine whether the new grey level is brighter or darker than the previous grey level.

According to a first embodiment, this may be determined by a signal processing approach, where the new grey level value is compared with the current grey level value, which is stored in a frame memory.

According to a second embodiment, the current grey level may first be measured using the actual output of the photo-sensor, and compare it with the new grey level. This may be carried out either one pixel at a time, or preferably one row at a lime, and this would require a much smaller pixel/row memory and an external comparator.

According to a third embodiment, the comparison of new grey level data and current grey level data may be carried out directly at pixel level, requiring no external memory or comparator.

Step 2

Connect the pixel to the appropriate polarity of driving voltage.

Once the outcome of step 1 is determined, the pixel electrode is connected either to the positive or negative voltage. In the example of FIG. 3, this is achieved by addressing one of the switching TFTs (TFT1 or TFT2). Depending on the implementation, this may be carried out by addressing a single addressing line or using two separate addressing lines.

Step 3

Monitor the grey scale level.

Here, the output of the photo-sensor is compared with the expected output for the new grey level, and is if necessary adjusted for ambient light as described above.

Step 4

Fix the new grey level.

When the output of the photo-sensor reaches the expected value for the new grey level, the voltage is removed from the pixel. This may be done by either isolating the pixel from the power line or by switching off the power lines, depending on implementation.

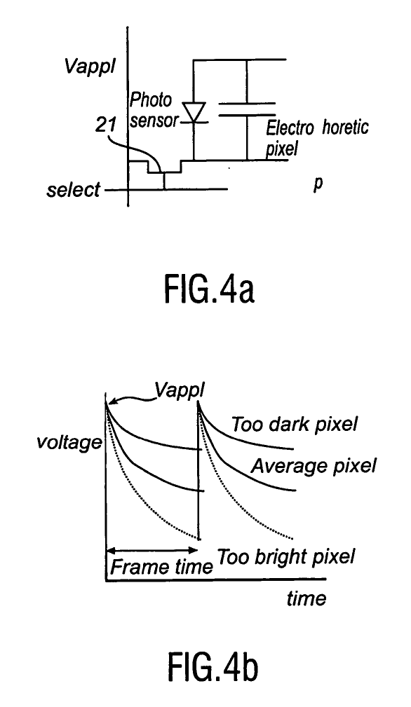

If necessary, it is possible to continue to monitor the photo-sensor output after the grey level has been fixed. In this case, if any drift in the grey level is noticed, for example beyond a predetermined grey level range, it would be possible to once again restore the desired grey level by repeating step 1-4 described above, using the same image data. Photo-sensor feedback may also be used to provide a more uniform grey level in a non-emissive display according to this invention, and specifically an electrophoretic displays. In this case, the output of the photo-sensor is used to modify the pixel addressing voltage, as is illustrated in FIG. 4a-4b.

Pixels, which are on average brighter will create a higher photo-current in the photo-sensor than pixels, which are on average darker. If a portion of this current is used to discharge the voltage across the pixel (and its associated storage capacitor), those pixels which are too bright will receive on average a lower voltage, as their pixel voltage will reduce more rapidly. This causes them to switch off less quickly, whereby they will reach a lower brightness that normal at the end of a driving period. In contrast, those pixels which are too dark will receive on average a higher voltage, as their pixel voltage will reduce more slowly. This causes them to switch more quickly, whereby they reaches a higher brightness than normal at the end of the driving period. In this way, as bright pixels are darkened and dark pixels are brightened, the perceived uniformity of the display is improved. In this case, there is no need to measure the absolute light output and compare this to a reference value.

Hence, a non-emissive display device according to the invention and specifically an electrophoretic display device have been achieved, which avoids problems with grey scale accuracy and drift by monitoring the grey scale level within the pixel and using an associated optical feedback signal to set the grey scale to the desired level. The feedback may either be completely used to set the grey scale, or could be used to fine tune an already set grey level, or could be used to prevent a set grey level from further drifting with time. This will be feasible as the non-emissive display and specifically the electrophoretic display according to the invention, may use an active matrix for driving, and the transistors of the active plate may be used to realise the grey scale detection and feed-back circuits. This is particularly suitable is a poly-Si process is used to form the active matrix, since CMOS transistor (p-type and n-type) and photodiodes are readily available but may also be implemented in a-Si technology, by using diodes or MIM diodes or by using mono-crystalline Si (for example in micro-display applications).

Whilst in the above only grey levels are discussed, the invention is also applicable to full colour display devices, and specifically to electrophoretic full colour displays which use either a colour filter approach or intrinsic colouring of the pixels (for example by using particles of different colours within the electrophoretic display) in order to provide a full colour display.

It shall be noted that the term non-emissive display device as used in this invention shall be construed as a display device which operate using electro-optical modes, whereby scattering and/or absorption of light is arranged to occur within the pixel cell. It shall also be noted that the present invention may be used with several kinds of non-emissive displays, other than the electrophoretic display described above. For example, the invention may be used with displays based on polymer dispersed liquid crystals (PDLC), cholesteric textured liquid crystals (CTLC), Guest-host systems (G-H) electrochromic systems, “Gyricon” systems (trademark of Xerox Corp.) and hybride switchable mirror systems (HM), as for example described in the patent application PCT/IB01/02516.

1. A non-emissive display device which is arranged to operate using electro-optical modes, said display device comprising at least one individually addressable pixel, wherein at least one of scattering and absorption of light is arranged to occur within said pixel, characterized in that the device comprises means for monitoring a grey scale level within said at least one pixel, means for adjusting the grey scale level of said pixel and means for feeding grey scale information from said monitoring means to said adjusting means in order to control said adjusting means.

2. A display device as claimed in claim 1, whereby said display device has a bi-stable nature.

3. A display device as claimed in claim 1, whereby said display device is an electrophoretic display device.

4. The display device as claimed in claim 1, wherein said monitoring means comprises a photo-sensitive device, arranged within said pixel.

5. The display device as claimed in claim 4, wherein said display device is of a reservoir type, wherein the pixel has an associated reservoir, said photo-sensitive device being arranged in proximity with a reflective element of said pixel.

6. The display device as claimed in claim 4, wherein said photo-sensitive device is a structured device being arranged on the surface of said reflective element.

7. The display device as claimed in claim 1, wherein said display device is an electronic ink display device.

8. The display device as claimed in claim 5, wherein said photo-sensitive device is arranged to monitor the amount of light scattered from said pixel.

9. The display device as claimed in claim 1, wherein said adjusting means is arranged to completely set a desired grey scale level, to fine-tune an already set grey scale level or to prevent a set grey level from further drifting in time.

10. The display device as claimed in claim 1, comprising a plurality of individually addressed pixels, further comprising means for measuring an intensity of ambient light falling onto said display device, wherein the information regarding the ambient light intensity may be used as a reference for the grey scale level.

11. The display device according to claim 1, further comprising a pixel control circuit comprising comparator means for comparing an output signal of the photo-sensitive device with a reference signal.

12. The display device according to claim 11, wherein the output of said comparator means is arranged to modify the driving signal of the pixel.

13. The display device according to claim 11, wherein said pixel circuit comprises a photo-sensitive device, which is arranged to reduce or discharge the pixel voltage.

14. The display device as claimed in claim 10, wherein said means for measuring an intensity of ambient light comprises a plurality of photodiodes being arranged in said display device.

15. The display device as claimed in claim 1, wherein said display device is a colour display device.

16. Use of a photodiode in an individually addressable pixel of a non-emissive display device according to claim 1 for monitoring ambient light.

17. A method for driving a pixel of a non-emissive display device which is arranged to operate using electro-optical modes, wherein scattering and/or absorption of light is arranged to occur within said pixel, as described in claim 1, comprising the following steps:
monitoring, by means of a monitoring means, a grey scale level of said pixel,
feeding grey scale level information as provided by said monitoring means, to a pixel grey scale adjusting means arranged for said pixel, and
adjusting the grey scale level of said pixel, based on said grey scale level information.
